(19) United States
(12) Patent Application Publication
(10) Pub. No.: US 2020/0072963 A1
(43) Pub. Date: Mar. 5, 2020

(54) DEVICE RADAR SENSING

(71) Applicant: INTEL IP CORPORATION, Santa Clara, CA (US)

(72) Inventors: Zhibin Yu, Unterhaching (DE); Bernhard Raaf, Neuried (DE); Markus Dominik Mueck, Neubiberg (DE); Duncan Kitchin, Beaverton, OR (US); Biljana Badic, Duesseldorf (DE)

(73) Assignee: INTEL IP CORPORATION, Santa Clara, CA (US)

(21) Appl. No.: 16/490,218

(22) PCT Filed: Mar. 31, 2017
(86) PCT No.: PCT/US2017/025524

§ 371 Date: Aug. 30, 2019

(51) Int. Cl. G01S 13/93

(52) U.S. Cl. CPC G01S 13/931; G01S 2013/936

(57) ABSTRACT

A system and method for radar sensing, including a control system performing radar sensing based on a data communication signal.

### TECHNICAL FIELD

The present techniques relate generally to device radar sensing and, more particularly, to utilizing data communication for device radar sensing.

### BACKGROUND

Vehicle-to-everything (V2X) communication and similar standards may involve the passing of information between a vehicle and other entity. The vehicular communication system may incorporate specific types of communication such as V2I (vehicle-to-infrastructure), V2V (vehicle-to-vehicle), V2P (vehicle-to-pedestrian), V2D (vehicle-to-device), V2G (vehicle-to-grid), and so on. V2X communication may be based at least in part on wireless local area network (WLAN) technology and work between vehicles, between vehicles and infrastructure, and between infrastructure devices. In particular examples, the radio technology may be standardized as part of the WLAN Institute of Electrical and Electronics Engineers (IEEE) 802.11 family of standards, and known as Wireless Access in Vehicular Environments (WAVE) in the United States and as Intelligent Transport Systems (ITS)-G5 in Europe.

V2X communication may work directly between vehicles or the infrastructure, which form a vehicular ad-hoc network, as two V2X senders come within each other's range. Hence, for vehicles to communicate (e.g., vehicle-to-vehicle or V2V), infrastructure may not be utilized. The V2V communication may transmit various messages or safety messages including, for example, common awareness messages (CAM), decentralized notification messages (DENM), basic safety message (BSM), and so forth.

### BRIEF DESCRIPTION OF THE DRAWINGS

FIG. 1 is a diagram depicting vehicle communication between a first vehicle 102 and a second vehicle in accordance with embodiments of the present techniques.

FIG. 2 is a first exemplary vehicle transceiver system in accordance with embodiments of the present techniques.

FIG. 3 is a second exemplary vehicle transceiver system in accordance with embodiments of the present techniques.

FIG. 4 is a bar chart over time in accordance with embodiments of the present techniques.

FIG. 5 is a vehicle computer system performing active radar sensing in accordance with embodiments of the present techniques.

FIG. 6 is a block diagram of a method of vehicle radar sensing utilizing data communication in accordance with embodiments of the present techniques.

FIG. 7 is a diagram depicting vehicle radar sensing between two vehicles using data communication in accordance with embodiments of the present techniques.

FIG. 8 is a block diagram of method of vehicle radar sensing in accordance with embodiments of the present techniques.

FIG. 9 is a block diagram illustrating a computer-readable medium to facilitate vehicle radar sensing using data communication in accordance with embodiments of the present techniques.

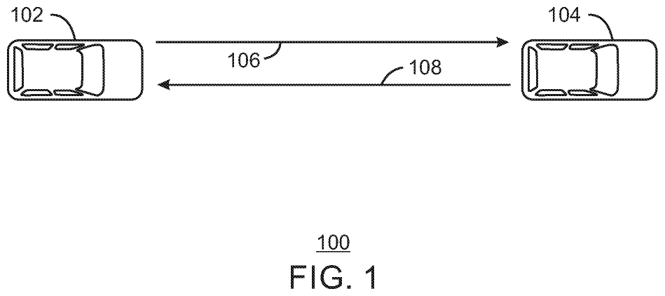

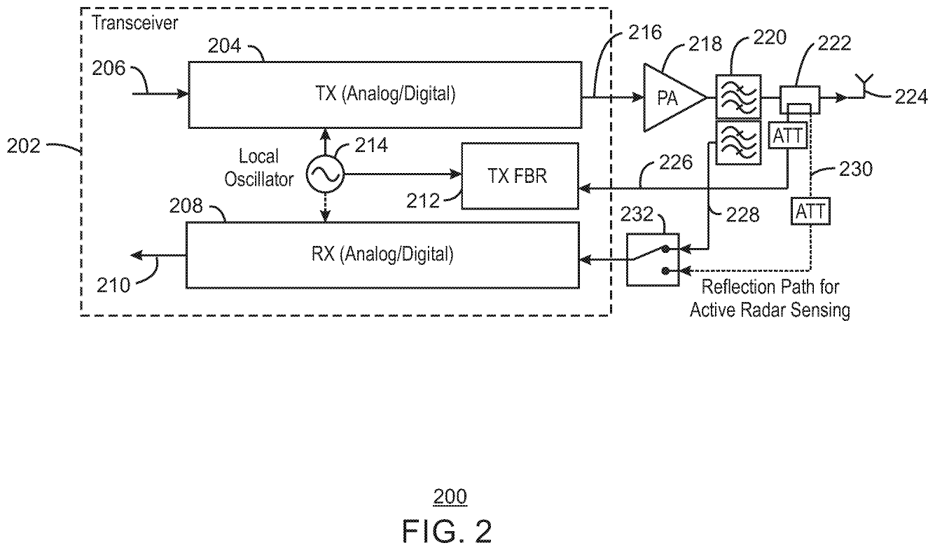

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The present techniques may involve aspects of V2X communication and similar standards. In some embodiments, the techniques may be directed to using data communication (e.g., V2V communication) signals for radar sensing. The radar sensing may be in addition to the data communication.

FIG. 1 is a diagram 100 depicting vehicle communication (e.g., vehicle-to-vehicle or V2V) between a first vehicle 102 and a second vehicle 104. The vehicles 102 and 104 may also represent devices or machines other than vehicles. Thus, the communications may be device-to-device (D2D), vehicle-to-device (V2D), machine-to-machine (M2M), vehicle-to-machine (V2M), etc. Moreover, the protocol can include Multi-Fire, sensor network, mash network, and other protocols.

In the illustrated example, the first vehicle 102 sends a signal or message 106 to the second vehicle 104. In particular, a vehicle computer system or user equipment (UE) of the first vehicle 102 may send the signal or message 106 to a vehicle computer system or UE of the second vehicle 104. Further, the second vehicle 104 sends a signal or message 108 to the first vehicle 102. In particular, the vehicle computer system or UE of the second vehicle 104 may send the signal or message 108 to the vehicle computer system or UE of the first vehicle 102.

In some examples, the communication or messaging between the vehicles 102 and 104 may rely on millimeter band or millimeter wave (mmWave) which may be a band of radio frequencies in the electromagnetic spectrum from 30 to 300 gigahertz (GHz). The mmWave may have wavelengths ranging from 10 to 1 millimeters (mm). Other frequency bands may be employed for the communication between the vehicles 102 and 104.

The V2V communication or similar standard may generally involve vehicle operations and wireless mobile telecommunications such as fourth generation (4G) and fifth generation (5G) (e.g., mmWave V2V). Aspects of the V2V data communication may be based on “message exchange” or “safety message exchange.” The message (e.g., message 106) may be transmitted from one vehicle (e.g., vehicle 102) to another vehicle (e.g., vehicle 104) through V2V communication links to provide useful information including risks and potential traffic accidents, and other information. The V2V communication may rely on decoding of the information of a message 106, 108 and with both vehicles 102, 104 active in the communication links. As discussed below, the present techniques are directed to using these communication signals for radar sensing.

Indeed, some embodiments include systems and methods for reusing the V2V communication waveforms for vehicle radar sensing (e.g., short-range). The communication waveforms may be the mmWave communications as signals or messages 106, 108. Certain embodiments address vehicle operation, e.g., auto-driving, etc., by physical signal detection of incoming wireless mobile telecommunications signals 106, 108 (e.g., 5G mmWave signals) of the V2V or similar standard. The physical detection may be in addition to the communication message exchange. In other words, transmitted and received physical layer signals employ by typical V2V communications may be additionally used for radar sensing including short-range radar sensing. In some examples, the ultra-high signal bandwidth for the incoming 5G mmWave-based V2V, and therefore the ultra-high sampling rate, may be beneficial to facilitate short-range (e.g., 1-15 meters) radar resolution for vehicle operations including vehicle operational and safety applications.

Certain embodiments of the radar sensing may rely on a reference signal embedded within the data communication signal. For example, the radar sensing may rely on a signal preamble or pilot signal of the communication. A preamble may be a signal in network communications to synchronize transmission timing between two or more systems. In general, preamble may be a synonym for “introduction.” In some examples, the role of the preamble is to define a specific series of transmission criteria. Timing may be beneficial to facilitate that systems to interpret the start of the information transfer. The actual preamble varies depending on the network communication technology. In wireless transmissions, the radio preamble (which may also be called a header) may be a section of data at the head of a packet. In some examples, the preamble may be used to synchronize a data transmission by indicating the end of header information and the start of data. The length of the preamble can affect the time taken to transmit data by increasing the packet overhead.

Two subsets of the radar sensing may be active radar sensing and passive radar sensing. Additional subsets may be realized or employed. Active radar sensing in certain examples may be implemented by detecting the reflected preamble signal originally transmitted by the UE of the vehicle itself. In other words, for active radar sensing by a first vehicle, the first vehicle may transmit a communication signal to a second vehicle, and the first vehicle detect the preamble of the signal as reflected from the second vehicle (or as reflected from an obstacle such as a wall or obstruction). For passive sensing, the second vehicle may use the incoming communication signal from the first vehicle.

Passive radar sensing may be implemented by detecting the incoming preamble signal timing-offset from the UE of another vehicle. Some examples may assume that V2V vehicles have a same timing basis synchronized by the global navigation satellite system (GNSS), for instance. The GNSS may be already defined, for example, by the synchronization source for the 3rd Generation Partnership Project (3GPP) (e.g., release 14 V2V standard), so the timing offset may reflect the propagation delay which may be determined by or as distance between vehicles. As known, 3GPP unites telecommunications standard development organizations and is generally a 3rd generation (3G) mobile system based on the evolved global system for mobile communication (GSM) core networks. 3GPP performs technical and specifications work on 5G network technology.

A preamble signal can be normal synchronization signals or channel estimation pilots employed by regular V2V communications. For example, such may include signals with respect to demodulation reference signal (DMRS) for release 14 V2V or reference signals in upcoming mmWave V2V standards, and so on. Moreover, active radar sensing and passive radar sensing can co-exist. For instance, the V2V signal transmitting UE vehicle detects the reflected signals as active radar sensing, while the V2V signal receiving car detects the incoming signals as passive radar sensing.

Furthermore, in comparison to the communication with the message-based approach, the radar sensing as described herein may have smaller latency because detection is in the physical layer. The lower latency may give vehicles more time margin to detect the traffic risks earlier, for example, and apply safety actions earlier. Meanwhile, in examples, both vehicles or peers do not need to be link active. For example, the active radar can not only detect another car which supports V2V, but also detect another obstacle that does not perform communications. In one example, a vehicle may transmit a data communication signal toward an object (not necessarily another vehicle), and then perform active radar sensing based on a reflection of the data communication signal received by the vehicle as reflected from the object.

For active radar sensing, the UE receiver may detect the reflected preamble or pilot signal transmitted by UE transmitter itself. In telecommunications, a pilot signal may be a signal (e.g., at a single frequency) transmitted over a communications system for supervisory, control, equalization, continuity, synchronization, or reference purposes. Depending on the implementation, both the preamble signal (generally used for synchronization) and the pilot signal (e.g., a reference signal) employed for data communication can be employed in radar sensing in embodiments herein. Further, the payload data may also be considered, and including with respect to DMRS.

To unblock typical V2V data communications, some embodiments may implement the active radar sensing generally without transmitter/receiver switching. As discussed below, this may be implemented at least in part by (1) operating a receiver (RX) in the same or similar carrier frequency as the transmitter, and (2) providing received IQ samples to digital processors to estimate the reflection profile. Quadrature signals, also called IQ signals, IQ data or IQ samples, are often used in radio frequency (RF) applications. The IQ samples may form the basis of complex RF signal modulation and demodulation, both in hardware and in software, as well as in complex signal analysis, and the like.

To operate a RX in the same carrier frequency as the TX, the setting(s) of the RX local oscillator (LO) may be operates the same or similar as the relevant setting(s) of the TX local oscillator (LO), or share the LO between TX and RX. Furthermore, the low noise amplifiers (LNA) in the RX front end may be protected by attenuating the received signals in the RX. In other words, because when the TX and the RX are operating in the same or similar frequency at the same time, the transmission signal may be directly coupled into the RX and with a power level which could damage the front-end devices (e.g. LNA) in the RX if not attenuated.

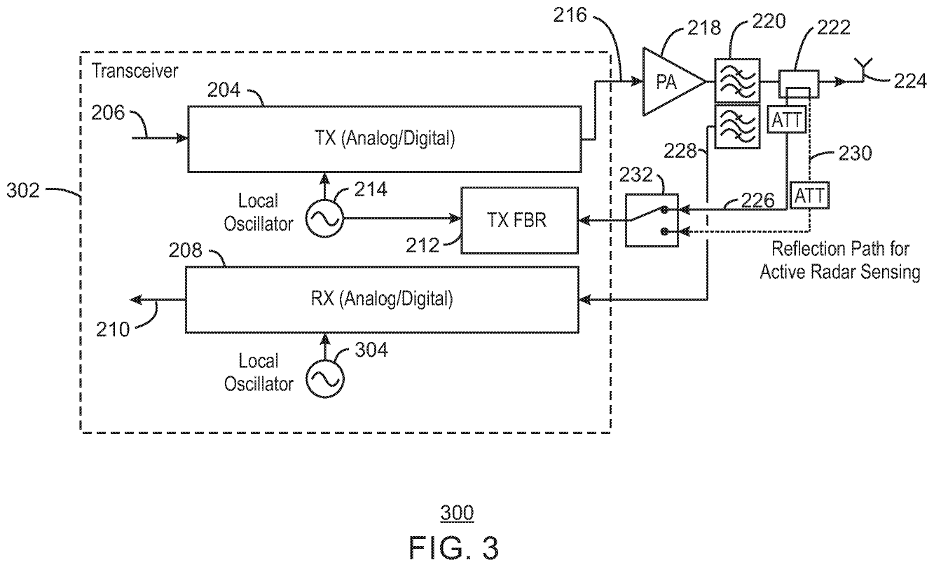

FIG. 2 and FIG. 3 are block diagrams representing examples of RF implementation to support radar sensing such as active radar sensing. FIG. 2 is directed to a downlink RF receiver for the active radar sensing. FIG. 3 is directed to a TX feedback receiver (FBR) for the active radar sensing.

FIG. 2 is an exemplary transceiver system 200 having a transceiver 202. The transceiver may be a component of a control system of a device or machine. The transceiver system 200 may be a component or subsystem of the vehicle control system, vehicle computer system or UE, and the like. The transceiver 202 includes a TX 204 which may be analog or digital, and receives an input 206 to transmit from the vehicle computing system or UE. In addition, the transceiver 202 includes an RX 208 which may be analog or digital, and provides a signal 210 to the vehicle computing system or UE. Further, the transceiver 202 includes a TX feedback receiver (FBR) 212 which may receive a signal from the LO 214. Indeed, the TX FBR 212 may operate at a same or similar frequency as the TX 204. Moreover, both the TX 204 and RX 208 receive a signal from the LO 214 of the transceiver 204 and also thus may operate at the same carrier frequency and same time synchronization. The TX 204 of one vehicle may operate at the same frequency as the RX 208 of another vehicle. In the transceiver system 200, the output 216 of the TX 204 is routed through a power amplifier (PA) 218 and a duplexer 220 before being emitted via an antenna 224 for the data communication. A coupler 222 decouples the RF signals from TX forward path and TX feedback path.

The receipt of data communication is via the antenna 224. A signal 226 is routed to the TX FBR 212. That path for the signal 226 includes an attenuator (ATT) to protect the TX FBR 226. Further, a signal 228 from the duplexer 220 may be routed to the RX 208. However, a path or signal 230 may be routed to the RX 208 via the switch 232. The add-on path 230 is to accommodate radar sensing. The add-on path 230 includes an additional attenuator (ATT) to protect the RX 208.

FIG. 2 shows an example of RF implementation block-diagram to support active radar sensing based on normal downlink RF receiver. Implemented is the add-on path 230 (marked as a dashed line), and the switch 232 to route bypass the TRX duplexer 200 for the reflection path 230. Also in this example mode, the reflected signal 230 is routed into the normal RX 208 shares the same LO 214 with the TX 204. That is because in this mode, the RX 208 may operate in the same or similar carrier frequency as TX 204 in a fully or substantially-fully synchronized manner. Thus, FIG. 2 is an RF block diagram to enable active radar sensing using a normal or typical receiver, though abnormal or atypical receivers may be employed.

FIG. 3 is an exemplary transceiver system 300 having a transceiver 302, as with system 200 of FIG. 2, but with the active radar sensing directed to the TX FBR 212. Thus, FIG. 3 shows an example of RF implementation block diagram to support active radar sensing, based on TX FBR 212. The system includes the add-on path 230 (dash line) which includes an additional ATT to protect the TX FBR 212, and with the switch 232 to route the reflected path 230 to the TX FBR 212. Here, the normal RF receiver 208 can be used for legacy downlink reception without being interrupted. The TX FBR 212 may generally operate in the same carrier frequency as the TX 204. For transceiver 302, the RX 208 is associated with a different LO 304. The TX FBR 212 may originally be used for transmission power control, which is generally activated for this purpose during power ramp, while the remaining idle time of the TX FBR 212 can be used for radar sensing in some examples. The system to facilitate active radar sensing using the TX FBR 212.

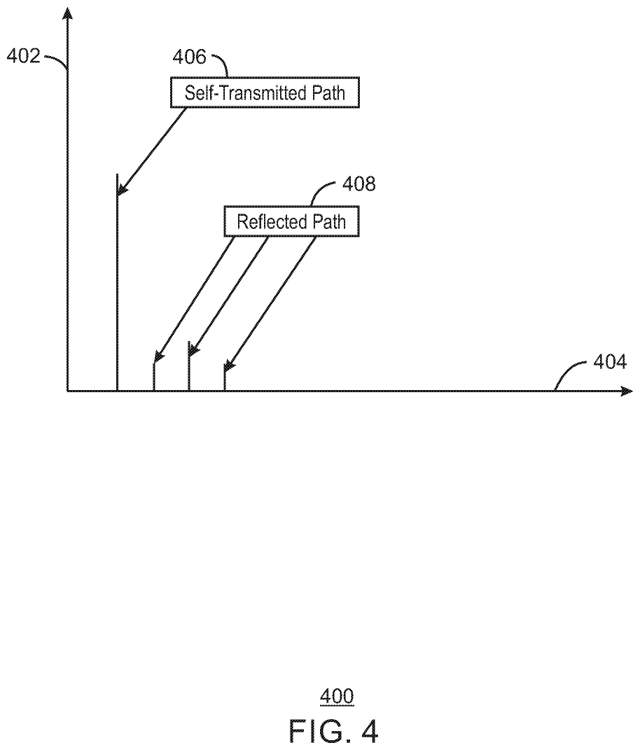

As mentioned, received IQ samples may be provided to digital processors such as digital signal processors (DSP) or other microprocessors to estimate the reflection profile. In some examples, a DSP may receive the digital IQ samples from an analog-digital-converter (ADC) and perform the post processing. Estimating of the reflection profile may be implemented by descrambling the received signal via a local template (e.g., local preamble or pre-stored transmitted IQ data), and then applying channel estimation to reconstruct the time-domain channel impulse response (CRI). FIG. 4 gives an example of CRI.

FIG. 4 is a bar chart 400 of h_est(t) 402 versus time 404. The h_est(t) 402 may be the estimated time-domain channel-impulse response which reflects the signal reflection profile for radar sensing. FIG. 4 gives an estimated CRI for active radar sensing. In FIG. 4, the strongest bin is self-transmitted signal or path 406 which is coupled from TX port to RX port, while the other weaker paths are reflected signal or path 408 are viewed as a (multiple) delayed paths from main path. The time interval between strongest path and the other paths further divided by 2 is correlative with distance between the UE transmitter and the reflecting obstacle. By this way, the reflection profile is estimated. The reflection profile may be given by creating the time-domain estimation of the reflected channel. The distance divided by two between the main self-transmitted path and the reflected paths may be the radar sensing distances. A less, lower, minimal, or least sensing range (radar resolution) may have correlate inversely with sampling rate. High bandwidth may give high sampling rate which may give a better radar resolution for short-range sensing.

In FIG. 4, the sensing distance can be derived from the timing difference between the self-transmitted path 406 and the reflected path 408 by the following formula: d=c*Δ/2, where c is speed of light and Δ is the timing delta. For passive radar, a low or the minimal radar sensing distance may be derived d=c*/(2*fs) where fs is the signal sampling rate. For mmWave V2V scenario, typically high bandwidth can be assumed. For example, if we assume 50 megahertz (MHz) system bandwidth of the transmitted signal, then the sampling rage is 100 MHz, it results in a minimal sensing distance of 1.5 meters (m), which is generally sufficient for short-range device (e.g., car) radar sensing.

Note that certain embodiments of active radar sensing herein also work for legacy LTE system. In this case, the short-range radar sensing resolution may be achieved by making use of bandwidth aggregated transmitted signals (e.g. intra-band contiguous uplink carrier aggregation) where a single LO is during the transmission. For example, a product in which 60 MHz intra-band contiguous uplink carrier aggregation is supported, such may result in less or a minimal sensing distance of about 1.25 m when employing the active radar sensing.

In some embodiments, the radar sensing may involve performing coarse sensing for longer distance with smaller transmitting signal bandwidth, or performing fine sensing for short distance with high transmitting signal bandwidth. Moreover, with respect to the radar-sensing results, when a problem (e.g., in vehicle traffic, road conditions, weather, etc.) is detected, the data communication link may prioritize the transmission of messages related to or responsive to the problem and with increased transmission power. Further, again, for active radar sensing, the reflected data communication signal can be a reflection from another vehicle, or also be from other objects, e.g., a wall.

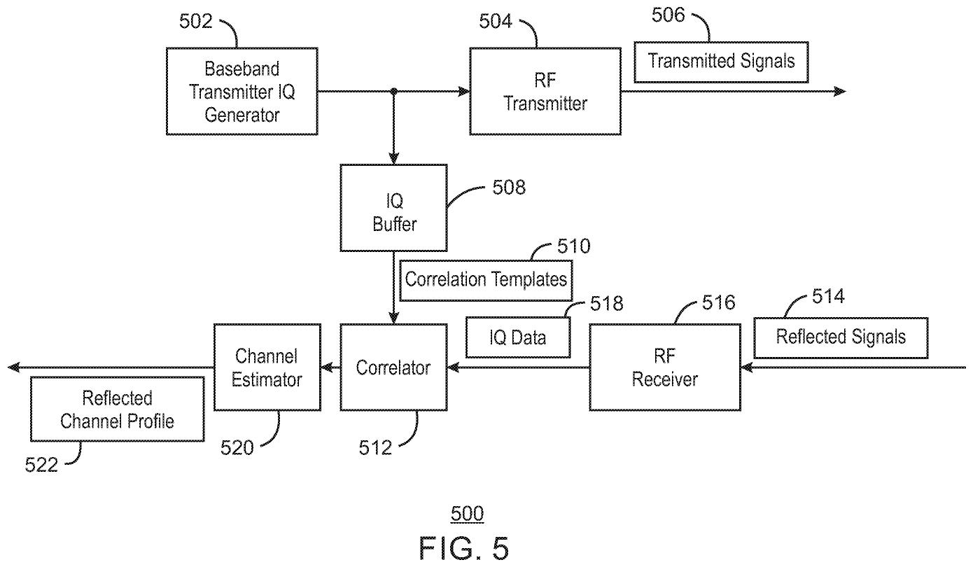

For active radar sensing, not only may pilot or preamble signals be utilized for the correlation template but also payload data may be similarly employed. An example may pre-store a set of transmission payload in a buffer before transmission, and use this buffer payload as the correlation template for the reflected signal for radar sensing. FIG. 5 shows an implementation example. FIG. 5 depicts active radar sensing using transmitted payload data as correlation templates.

FIG. 5 is a device control system 500 and in which in some examples may be vehicle computer system including, for instance, a UE. The system 500 is in operation as depicted to perform active radar sensing using transmitted payload data. The system 500 includes a baseband transmitter IQ generator 502. Further included is an RF transmitter 504 which outputs transmitted data signals 506 for communication (and having payload data), similar as discussed above with respect to FIGS. 2-3. In addition, an IQ buffer outputs correlation templates 510 to a correlator 512. Moreover, reflected communication data signals 514 (having the payload data) are received by an RF receiver 516, also similar as discussed above with respect to FIGS. 2-3. The correlator 512 receives IQ data 518 from the RF receiver 516. The correlator 512 and a channel estimator 520 give a reflected channel profile 522. The correlator 512 and the channel estimator 520 may be code (e.g., instructions, logic, etc.) stored in memory of the system 500 and executed by a processor of the system 500.

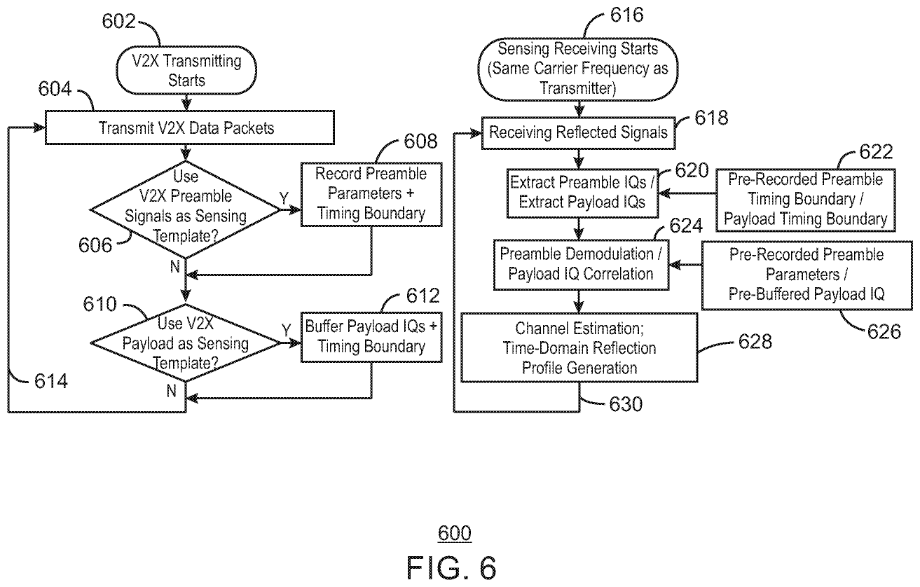

FIG. 6 is a method 600 of radar sensing utilizing data communication. FIG. 6 depicts a high-level baseband control procedure for both the transmitter side and the sensing receiver side. FIG. 6 indicates control flows of both the transmitter and the sensing receiver for radar sensing such as active radar sensing. At block 602, the V2X transmitting (data communication) starts. In other examples, M2M communication may be employed. At block 604, V2X data packets are transmitted. At decision diamond 606, if the method uses V2X preamble signals as a sensing template, the method at block 608 records preamble parameters and timing boundary. If not, the method proceeds to decision diamond 610 in which ask if the V2X payload to be used as sensing template. If yes, then at block 612 the method notes the buffer payload IQs and timing boundary. If not, the method continues through diamonds 606 and 610 until decided to employ the preamble or payload for radar sensing.

At block 618, sensing receiving starts and which in this example is at the same carrier frequency as the transmitter noted in block 602. At block 618, reflected signals are received. At block 620, the method 600 includes extracting preamble IQs and extracting payload IQs. In doing so, at block 622, a pre-recorded preamble timing boundary and payload timing boundary are received. At block 624, the method includes a preamble demodulation and a payload IQ correlation. In doing so, at block 626, the method receives a pre-recorded preamble parameter and pre-buffered payload IQ. Lastly, at block 630, the method performs channel estimation and time-domain reflection profile-generation. The method 600 may continue to receive (block 618) reflected signals and iterate or repeat the aforementioned actions.

For passive radar sensing, which may detect the incoming preamble signal timing-offset from another machine or device such as a UE vehicle, an embodiment assumes both devices or vehicles already have a same timing basis from GNSS timing. As a result, the timing offset is the propagation delay between devices (e.g., cars). GNSS is specified as the synchronization source for V2V communications since 3GPP release 14.

Moreover, orthogonal sequences including TDMA or FDMA schemes can be defined for radar sensing preamble signals, so as to mitigate interference between incoming preambles and self-reflected preambles. Time division multiple access (TDMA) is a channel access method for shared medium networks. TDMA may facilitate several users to share the same frequency channel by dividing the signal into different time slots. Frequency division multiple access or FDMA is generally a channel access technique or channelization protocol. FDMA may give users an individual allocation of one or several frequency bands, or channels. Further, beam-forming or beam-sweeping technology may be combined with the transmitter and the radar receiver to detect different reflection angles to accommodate near or at 360-degree surrounding obstacle detection.

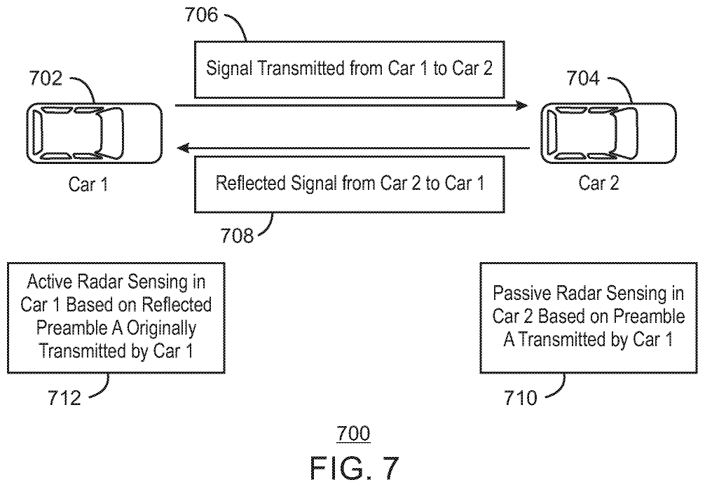

Moreover, passive radar sensing may also be implemented via V2X communication. For example, roadside units (RSUs) can be equipped with sensors to extend the view of the machines or devices (e.g., vehicles) beyond that of sensors of upcoming traffic. Furthermore, the active radar sensing and passive radar sensing can co-exist, as discussed below with respect to FIG. 7.

FIG. 7 is a diagram 700 depicting radar sensing by two vehicles 702 and 704 using data communication (e.g., V2V) between the two vehicles 702 and 704. The vehicles 702 and 704 may be devices or machines other than vehicles. Examples of co-existence of passive and active radar sensing using the same preamble signal may be implemented. For instance, UE of the first vehicle 702 may periodically send V2V data packets associated with preamble or pilot signals to another UE such as to the UE of the second vehicle 704. Thus, the second vehicle 704 may make use of the received preamble for passive radar sensing. Also, for active radar sensing, the UE of the first vehicle 702 may detect the reflected signal of its own transmitted preamble.

In the illustrated example, the UE of the first vehicle 702 (e.g., car) sends or transmits a data communication signal 706 (e.g., V2V) to the UE of the second vehicle 704 (e.g., car). Passive radar sensing (block 710) by the second vehicle 704 may be based on preamble A transmitted and associated with the signal 706. Moreover, from the signal 706, a reflected signal 708 is reflected from the second vehicle 704 to the first vehicle 702. Active radar sensing (block 712) by the first vehicle 702 may be based on the reflected preamble A associated with the reflected signal 708 and originally transmitted by the first vehicle 702.

Furthermore, radar sensing results may jointly optimize or improve the higher-level safety message exchange for V2V communications. A variable is that when a potential risk is detected by radar sensing, the communication link of the corresponding UE car may be prioritized higher than others. This can be done by allocating more resource blocks for the corresponding UE car or prioritize the data packet transmission and reception of the corresponding UE car. From the resource availability perspective, for constructing the radar signal, portions of most or all available bands may be considered, including licensed bands (such as future 3.6-3.8 GHz bands which are considered for cellular V2X) and unlicensed bands (such as 5.9 GHz), or in the mmWave bands for 5G, and so forth.

Furthermore, the applied signal bandwidth may be adapted for the emitted radar signal depending on a number of parameters, and with a dynamic tradeoff between resolution and sensitivity. The resolution of the multipath profile illustrated in FIG. 4 may depend on the applied bandwidth, e.g., higher bandwidth generally provides a higher resolution and therefore smaller minimal detectable distance. The penalty is, however, that the maximal sensing distance is reduced because the transmission power density of the transmitted signal may be reduced due to high bandwidth. On the other hand, lower bandwidth generally provides a lower resolution and therefore higher minimal detectable distance. The benefit is, however, that the maximal sensing distance may generally be increased because the transmission power density of the transmitted signal is increased due to low bandwidth. Therefore, for a rough estimation for a longer, a lower signal bandwidth may be applied which typically provides better sensitivity for long-range sensing. Yet, for a detailed estimation for short distance, a high or very-high signal bandwidth may be applied which generally provides better sensing resolution. Lastly, for certain examples, the radar preamble transmission can be done by normal transmitter component within a physical layer of a cellular modem. The radar sensing processing can be done by cell search component which applies the time and frequency synchronization of received preambles (either sent by another UE car or sent by the first UE car and reflected back).

An embodiment may include a vehicle having a vehicle computer system with a transceiver system, the vehicle computer system to: (1) transmit a data communication signal (e.g., V2V, mmWave, etc.) to a second vehicle; and (2) perform radar sensing based on the data communication signal as reflected from the second vehicle. The radar sensing may be based on the preamble (or other embedded reference signal) of the data communication signal. On the other hand, the radar sensing may be based on payload data of the data communication signal. The vehicle computer system may also receive a data communication signal transmitted by the second vehicle, and perform radar sensing based on this data communication signal as received.

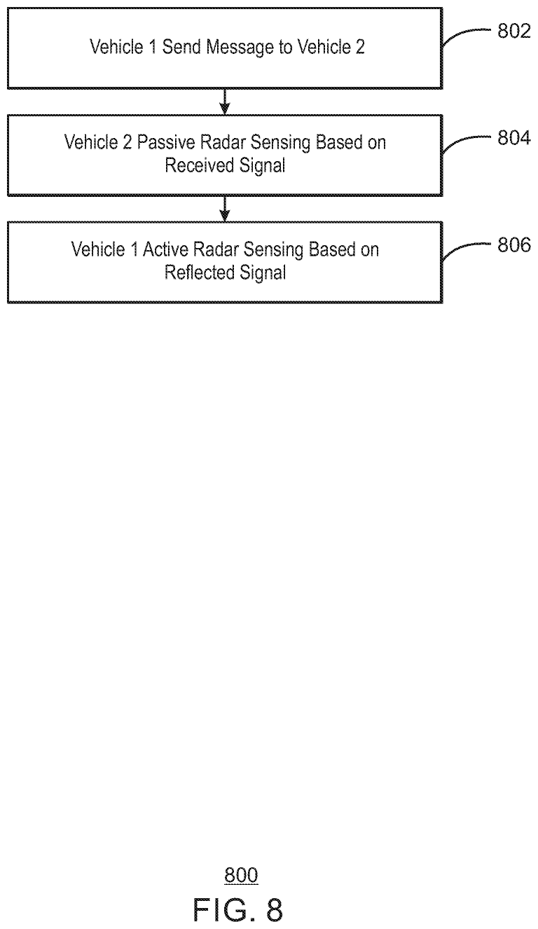

FIG. 8 is a method 800 of device (e.g., vehicle) radar sensing. At block 802, vehicle 1 sends a message (e.g., V2V) to vehicle 2. In other words, vehicle 1 transmits a communication signal to vehicle 2, such as over mmWave. At block 804, vehicle 2 performs passive radar sensing based on the communication signal received from vehicle 1, as with techniques discussed above. At block 806, vehicle 1 performs active radar sensing based on the communication signal as reflected from vehicle 2 (or from an obstacle such as a wall), as also discussed above. The radar sensing by the vehicles may be based on the preamble or payload data, and the like, of the communication signal. Devices or machines other than vehicles may employ method 800.

In some embodiments, the radar sensing may involve performing coarse sensing for longer distance with smaller transmitting signal bandwidth, or performing fine sensing for short distance with high transmitting signal bandwidth. Moreover, with respect to the radar-sensing results, when a problem (e.g., in vehicle traffic, road conditions, weather, etc.) is detected, the data communication link may prioritize the transmission of messages related to or responsive to the problem and with increased transmission power. Moreover, a device or vehicle may transmit a data communication signal toward an object (not necessarily another device or vehicle), and then perform active radar sensing based on a reflection of the data communication signal received by the vehicle as reflected from the object.

In summary, an embodiment is a method of vehicle radar sensing, including transmitting a data communication signal (e.g., mmWave, V2V) from a first vehicle to a second vehicle, and performing radar sensing by the first vehicle or the second vehicle, or both, based on the data communication signal. The radar sensing may be based on a preamble or payload data of the data communication signal. The method may include performing radar sensing by the second vehicle based on receipt of the data communication signal by the second vehicle. The method may include performing radar sensing by the first vehicle based on a reflection received by the first vehicle of the data communication signal.

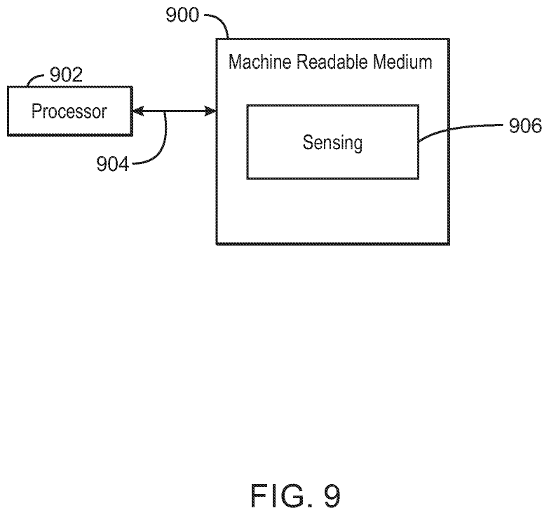

FIG. 9 is a block diagram depicting a tangible, non-transitory, computer-readable medium 900 to facilitate vehicle radar sensing using data communication as discussed herein. The computer-readable medium 900 may be accessed by a processor 902 over a computer interconnect 904. The processor 902 may be a processor of a vehicle computing system. The tangible, non-transitory, computer-readable medium 900 may include executable instructions or code to direct the processor 902 or vehicle computing system to perform the techniques described herein, such as to implement data communication and radar sensing based on the data communication.

The various software components discussed herein may be stored on the tangible, non-transitory, computer-readable medium 900, as indicated FIG. 9. For example, sensing code 906 (executable code/instructions) when executed by the processor 902 may direct the processor 902 to implement vehicle radar sensing using data communication signals. It should be understood that any number of additional software components not shown in FIG. 9 may be included within the tangible, non-transitory, computer-readable medium 900, depending on the application.

In some examples, a tangible, non-transitory, computer-readable medium includes sensing code 906 executable by a processor to direct a vehicle computer system of a vehicle to transmit a data communication signal to a second vehicle, and perform radar sensing based on the data communication signal as reflected from the second vehicle. The radar sensing may be based, for example, on a preamble or payload data of the data communication signal. The data communication signal may be a V2V communication over mmWave.

Lastly, multiple variations are applicable. For instance, in some examples with data communication performed in car radar bands (such as 76-81 GHz), the communication data itself can be used as radar signal. In other words, a purpose of the emission may be at least twofold: (i) the receiver may receive the signal, decode the signal, and extract the data; and (ii) the emitting device may receive reflections from surrounding obstacles (such as other cars) and use the reflections of the original emitted data to obtain or improve knowledge of the surrounding objects or otherwise radar functionality.

In certain examples with the radar signal different than the data signal, time multiplexing may be employed. The radar signal may be a non-data carrying signal and which may be adjusted or optimized. With respect to time multiplexing, a part or portion of the available transmission time may be reserved for the radar transmissions and another part of the available transmission time (e.g., typically the remaining time) reserved for data communication. Thus, the resource may be shared over time between radar and data communication functionalities.

Moreover, various standards and frequency bands may be applicable. Radio links may operate according to deferring radio communication technologies and/or standards. Examples include GSM radio communication technology, general packet radio service (GPRS) radio communication technology, enhanced data rates for GSM evolution (EDGE) radio communication technology, and/or 3GPP as mentioned, and so on. Example technologies may involve Universal Mobile Telecommunications System (UMTS), Freedom of Multimedia Access (FOMA), 3GPP Long Term Evolution (LTE), 3GPP LTE Advanced, Code Division Multiple Access 2000 (CDMA2000), Cellular Digital Packet Data (CDPD), Mobitex, 3G, Circuit Switched Data (CSD), High-Speed CSD (HSCSD), UMTS 3G, Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3G Partnership Project Release 8 (Pre-4th Generation) (3GPP Rel. 8 (Pre-4G)), 3GPP Rel. 9 (3G Partnership Project Release 9), 3GPP Rel. 10 (3G Partnership Project Release 10) , 3GPP Rel. 11 (3G Partnership Project Release 11), 3GPP Rel. 12 (3G Partnership Project Release 12), 3GPP Rel. 13 (3G Partnership Project Release 13), 3GPP Rel. 14 (3G Partnership Project Release 14), 3GPP Rel. 15 (3G Partnership Project Release 15), 3GPP Rel. 16 (3G Partnership Project Release 16), 3GPP Rel. 17 (3G Partnership Project Release 17), 3GPP Rel. 18 (3G Partnership Project Release 18), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), LTE Advanced 4G, cdmaOne (2G), CDMA2000 3G, Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems, Intelligent-Transport-Systems, and other technologies.

In addition, applications can be implemented in the context of spectrum management schemes including dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies). Applicable spectrum bands include IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc). Note that some bands are limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications. Furthermore, a hierarchical application of the scheme may be accommodated, such as by introducing a hierarchical prioritization of usage for different types of users (e.g., low/medium/high priority, etc.), based on a prioritized access to the spectrum e.g. with highest priority to tier-1 users, followed by tier-2, then tier-3, etc. users, etc. Schemes may also be applied, for example, to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources, and so forth.

A signal as referred to in communication systems, signal processing, and electrical engineering may be a function that conveys information about the behavior or attributes of some phenomenon. The term “signal” may include audio, video, speech, image, communication, geophysical, sonar, radar, medical and musical signals. In some examples, signals may be provided by a sensor, and the original form of a signal may be converted to another form of energy using a transducer. In certain examples of a communication system, a transmitter may encode a message to a signal which is carried to a receiver. Signals may be analog and digital. A digital signal may result from approximating an analog signal by values at particular time instants. Digital signals may be quantized, while analog signals can be continuous. Digital signals may arise via sampling of analog signals.

In the description and claims, the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit or receive signals, among others.

An embodiment is an implementation or example. Reference in the specification to “an embodiment”, “one embodiment”, “some embodiments”, “various embodiments”, or “other embodiments” means that a particular feature, structure, or characteristic described in connection with the embodiments is included in at least some embodiments, but not necessarily all embodiments, of the present techniques. The various appearances of “an embodiment”, “one embodiment”, or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can”, or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement or order of circuit elements or other features illustrated in the drawings or described herein need not be arranged in the particular way illustrated and described. Many other arrangements are possible according to some embodiments.

In each system shown in a figure, the elements in some cases may each have a same reference number or a different reference number to suggest that the elements represented could be different or similar. However, an element may be flexible enough to have different implementations and work with some or all of the systems shown or described herein. The various elements shown in the figures may be the same or different. Which one is referred to as a first element and which is called a second element is arbitrary.

Examples are given. Example 1 is a method of vehicle radar sensing. The method includes transmitting a data communication signal from a first vehicle to a second vehicle; and performing radar sensing by the first vehicle or the second vehicle, or both, based on the data communication signal.

Example 2 includes the method of example 1, including or excluding optional features. In this example, based on the data communication signal comprises based on a reference signal embedded within the data communication signal.

Example 3 includes the method of any one of examples 1 to 2, including or excluding optional features. In this example, based on the data communication signal comprises based on a preamble of the data communication signal.

Example 4 includes the method of any one of examples 1 to 3, including or excluding optional features. In this example, based on the data communication signal comprises based on payload data of the data communication signal.

Example 5 includes the method of any one of examples 1 to 4, including or excluding optional features. In this example, performing radar sensing comprises performing passive radar sensing by the second vehicle based on receipt of the data communication signal by the second vehicle. Optionally, performing radar sensing comprises performing active radar sensing by the first vehicle based on a reflection received by the first vehicle of the data communication signal.

Example 6 includes the method of any one of examples 1 to 5, including or excluding optional features. In this example, transmitting comprises transmitting the data communication signal over a millimeter wave (mmWave) band.

Example 7 includes the method of any one of examples 1 to 6, including or excluding optional features. In this example, the data communication signal comprises a vehicle-to-vehicle (V2V) communication.

Example 8 includes the method of any one of examples 1 to 7, including or excluding optional features. In this example, the method includes prioritizing a message in data communications between the first vehicle and the second vehicle to have increased transmission power in response to a result of the radar sensing.

Example 9 includes the method of any one of examples 1 to 8, including or excluding optional features. In this example, the method includes transmitting a second data communication signal from the first vehicle toward an object; and performing active radar sensing by the first vehicle based on a reflection received by the first vehicle of the second data communication signal.

Example 10 includes the method of any one of examples 1 to 9, including or excluding optional features. In this example, performing radar sensing comprises performing active radar sensing by the first vehicle based on a reflection received by the first vehicle of the data communication signal. Optionally, performing radar sensing comprises performing coarse sensing for a first distance with a first transmitting signal bandwidth, or performing fine sensing for a second distance with a second transmitting signal bandwidth, wherein the second distance is shorter than the first distance, and wherein the second transmitting signal bandwidth is higher than the first transmitting signal bandwidth.

Example 11 is a vehicle. The vehicle includes a vehicle computer system having a transceiver system, the vehicle computer system to: transmit a data communication signal to a second vehicle; and perform radar sensing based on the data communication signal as reflected from the second vehicle.

Example 12 includes the vehicle of example 11, including or excluding optional features. In this example, based on the data communication signal comprises based on a preamble of the data communication signal.

Example 13 includes the vehicle of any one of examples 11 to 12, including or excluding optional features. In this example, based on the data communication signal comprises based on payload data of the data communication signal.

Example 14 includes the vehicle of any one of examples 11 to 13, including or excluding optional features. In this example, the vehicle computer system to receive a second data communication signal transmitted by the second vehicle. Optionally, the vehicle computer system to perform radar sensing based on the second data communication signal as received.

Example 15 includes the vehicle of any one of examples 11 to 14, including or excluding optional features. In this example, the data communication signal comprises millimeter wave (mmWave).

Example 16 includes the vehicle of any one of examples 11 to 15, including or excluding optional features. In this example, the data communication signal comprises a vehicle-to-vehicle (V2V) communication.

Example 17 is a tangible, non-transitory computer-readable medium. The tangible, non-transitory computer-readable medium includes instructions that direct the processor to transmit a data communication signal to a second vehicle; and perform radar sensing based on the data communication signal as reflected from the second vehicle.

Example 18 includes the tangible, non-transitory computer-readable medium of example 17, including or excluding optional features. In this example, based on the data communication signal comprises based on a preamble of the data communication signal.

Example 19 includes the tangible, non-transitory computer-readable medium of any one of examples 17 to 18, including or excluding optional features. In this example, based on the data communication signal comprises based on payload data of the data communication signal.

Example 20 includes the tangible, non-transitory computer-readable medium of any one of examples 17 to 19, including or excluding optional features. In this example, the code executable by the processor to direct the vehicle computer system to receive a second data communication signal transmitted by the second vehicle. Optionally, the code executable by the processor to direct the vehicle computer system to perform radar sensing based on the second data communication signal as received.

Example 21 includes the tangible, non-transitory computer-readable medium of any one of examples 17 to 20, including or excluding optional features. In this example, the data communication signal comprises a vehicle-to-vehicle (V2V) communication over millimeter wave (mmWave).

Example 22 is a method of vehicle radar sensing. The method includes instructions that direct the processor to evaluating a data communication signal transmitted from a first vehicle to a second vehicle; and performing radar sensing by the first vehicle or the second vehicle, or both, based on the data communication signal.

Example 23 includes the method of example 22, including or excluding optional features. In this example, based on the data communication signal comprises based on a reference signal embedded within the data communication signal. Optionally, the reference signal comprises a preamble of the data communication signal.

Example 24 includes the method of any one of examples 22 to 23, including or excluding optional features. In this example, based on the data communication signal comprises based on payload data of the data communication signal.

Example 25 includes the method of any one of examples 22 to 24, including or excluding optional features. In this example, performing radar sensing comprises performing passive radar sensing by the second vehicle based on receipt of the data communication signal by the second vehicle. Optionally, performing radar sensing comprises performing active radar sensing by the first vehicle based on a reflection received by the first vehicle of the data communication signal.

Example 26 includes the method of any one of examples 22 to 25, including or excluding optional features. In this example, the data communication signal is transmitted over a millimeter wave (mmWave) band.

Example 27 includes the method of any one of examples 22 to 26, including or excluding optional features. In this example, the data communication signal comprises a vehicle-to-vehicle (V2V) communication.

Example 28 includes the method of any one of examples 22 to 27, including or excluding optional features. In this example, the method includes prioritizing, by a vehicle computer system, a message in data communications between the first vehicle and the second vehicle to have increased transmission power in response to a result of the radar sensing.

Example 29 includes the method of any one of examples 22 to 28, including or excluding optional features. In this example, the method includes transmitting a second data communication signal from the first vehicle toward an object; and performing active radar sensing by the first vehicle based on a reflection received by the first vehicle of the second data communication signal.

Example 30 includes the method of any one of examples 22 to 29, including or excluding optional features. In this example, performing radar sensing comprises performing active radar sensing by the first vehicle based on a reflection received by the first vehicle of the data communication signal. Optionally, performing radar sensing comprises performing coarse sensing for a first distance with a first transmitting signal bandwidth, or performing fine sensing for a second distance with a second transmitting signal bandwidth, wherein the second distance is shorter than the first distance, and wherein the second transmitting signal bandwidth is higher than the first transmitting signal bandwidth.

Example 31 is a vehicle. The vehicle includes a vehicle computer system having a transceiver system, the vehicle computer system to: transmit a data communication signal; and perform radar sensing based on the data communication signal as reflected from a second vehicle or from an object, or a combination thereof.

Example 32 includes the vehicle of example 31, including or excluding optional features. In this example, based on the data communication signal comprises based on a reference signal embedded in the data communication signal.

Example 33 includes the vehicle of any one of examples 31 to 32, including or excluding optional features. In this example, based on the data communication signal comprises based on a preamble of the data communication signal.

Example 34 includes the vehicle of any one of examples 31 to 33, including or excluding optional features. In this example, based on the data communication signal comprises based on a pilot signal associated with the data communication signal.

Example 35 includes the vehicle of any one of examples 31 to 34, including or excluding optional features. In this example, based on the data communication signal comprises based on payload data of the data communication signal.

Example 36 includes the vehicle of any one of examples 31 to 35, including or excluding optional features. In this example, the vehicle computer system to receive a second data communication signal transmitted by the second vehicle. Optionally, the vehicle computer system to perform radar sensing based on the second data communication signal as received.

Example 37 includes the vehicle of any one of examples 31 to 36, including or excluding optional features. In this example, the data communication signal comprises millimeter wave (mmWave).

Example 38 includes the vehicle of any one of examples 31 to 37, including or excluding optional features. In this example, the data communication signal comprises a vehicle-to-vehicle (V2V) communication.

Example 39 is a tangible, non-transitory computer-readable medium. The tangible, non-transitory computer-readable medium includes instructions that direct the processor to transmit a data communication signal; and perform radar sensing based on the data communication signal as reflected from a second vehicle or from an object.

Example 40 includes the tangible, non-transitory computer-readable medium of example 39, including or excluding optional features. In this example, based on the data communication signal comprises based on a reference signal embedded in the data communication signal.

Example 41 includes the tangible, non-transitory computer-readable medium of any one of examples 39 to 40, including or excluding optional features. In this example, based on the data communication signal comprises based on a preamble of the data communication signal.

Example 42 includes the tangible, non-transitory computer-readable medium of any one of examples 39 to 41, including or excluding optional features. In this example, based on the data communication signal comprises based on a pilot signal associated with the data communication signal.

Example 43 includes the tangible, non-transitory computer-readable medium of any one of examples 39 to 42, including or excluding optional features. In this example, based on the data communication signal comprises based on payload data of the data communication signal.

Example 44 includes the tangible, non-transitory computer-readable medium of any one of examples 39 to 43, including or excluding optional features. In this example, the code executable by the processor to direct the vehicle computer system to receive a second data communication signal transmitted by the second vehicle. Optionally, the code executable by the processor to direct the vehicle computer system to perform radar sensing based on the second data communication signal as received.

Example 45 includes the tangible, non-transitory computer-readable medium of any one of examples 39 to 44, including or excluding optional features. In this example, the data communication signal comprises a vehicle-to-vehicle (V2V) communication over millimeter wave (mmWave).

Example 46 is a method of vehicle radar sensing. The method includes instructions that direct the processor to transmitting a data communication signal from a first vehicle to a second vehicle; performing radar sensing by the first vehicle or the second vehicle, or both, based on the data communication signal; and prioritizing a message in data communications between the first vehicle and the second vehicle to have increased transmission power in response to a result of the radar sensing.

Example 47 includes the method of example 46, including or excluding optional features. In this example, based on the data communication signal comprises based on a reference signal embedded within the data communication signal. Optionally, the reference signal comprises a preamble or a pilot.

Example 48 includes the method of any one of examples 46 to 47, including or excluding optional features. In this example, based on the data communication signal comprises based on payload data of the data communication signal.

Example 49 includes the method of any one of examples 46 to 48, including or excluding optional features. In this example, performing radar sensing comprises performing passive radar sensing by the second vehicle based on receipt of the data communication signal by the second vehicle. Optionally, performing radar sensing comprises performing active radar sensing by the first vehicle based on a reflection received by the first vehicle of the data communication signal.

Example 50 includes the method of any one of examples 46 to 49, including or excluding optional features. In this example, transmitting comprises transmitting the data communication signal over a millimeter wave (mmWave) band, and wherein the data communication signal comprises a vehicle-to-vehicle (V2V) communication.

Example 51 is a vehicle. The vehicle includes instructions that direct the processor to a vehicle computer system having a transceiver system, the vehicle computer system to: transmit a data communication signal to a second vehicle, wherein the data communication signal comprises millimeter wave (mmWave) and vehicle-to-vehicle (V2V) communication; and perform radar sensing based on the data communication signal as reflected from the second vehicle.

Example 52 includes the vehicle of example 51, including or excluding optional features. In this example, based on the data communication signal comprises based on a preamble of the data communication signal or on payload data of the data communication signal.

Example 53 includes the vehicle of any one of examples 51 to 52, including or excluding optional features. In this example, the vehicle computer system to: receive a second data communication signal transmitted by the second vehicle; and perform radar sensing based on the second data communication signal as received.

Example 54 is a tangible, non-transitory computer-readable medium. The tangible, non-transitory computer-readable medium includes instructions that direct the processor to transmit a data communication signal to a second vehicle, wherein the data communication signal comprises millimeter wave (mmWave) and vehicle-to-vehicle (V2V) communication; and perform radar sensing based on the data communication signal as reflected from the second vehicle.

Example 55 includes the tangible, non-transitory computer-readable medium of example 54, including or excluding optional features. In this example, based on the data communication signal comprises based on a preamble of the data communication signal or based on payload data of the data communication signal.

Example 56 includes the tangible, non-transitory computer-readable medium of any one of examples 54 to 55, including or excluding optional features. In this example, the code executable by the processor to direct the vehicle computer system to: receive a second data communication signal transmitted by the second vehicle; and perform radar sensing based on the second data communication signal as received.

Example 57 is a system for vehicle radar sensing. The system includes means for transmitting a data communication signal from a first vehicle to a second vehicle; and means for performing radar sensing by the first vehicle or the second vehicle, or both, based on the data communication signal.

Example 58 includes the system of example 57, including or excluding optional features. In this example, based on the data communication signal comprises based on a reference signal embedded within the data communication signal.

Example 59 includes the system of any one of examples 57 to 58, including or excluding optional features. In this example, based on the data communication signal comprises based on a preamble of the data communication signal.

Example 60 includes the system of any one of examples 57 to 59, including or excluding optional features. In this example, based on the data communication signal comprises based on payload data of the data communication signal.

Example 61 includes the system of any one of examples 57 to 60, including or excluding optional features. In this example, the means for performing radar sensing comprises means for performing passive radar sensing by the second vehicle based on receipt of the data communication signal by the second vehicle. Optionally, the means for performing radar sensing comprises means for performing active radar sensing by the first vehicle based on a reflection received by the first vehicle of the data communication signal.

Example 62 includes the system of any one of examples 57 to 61, including or excluding optional features. In this example, the means for transmitting comprises means for transmitting the data communication signal over a millimeter wave (mmWave) band.

Example 63 includes the system of any one of examples 57 to 62, including or excluding optional features. In this example, the data communication signal comprises a vehicle-to-vehicle (V2V) communication.

Example 64 includes the system of any one of examples 57 to 63, including or excluding optional features. In this example, the system includes means for prioritizing a message in data communications between the first vehicle and the second vehicle to have increased transmission power in response to a result of the radar sensing.

Example 65 includes the system of any one of examples 57 to 64, including or excluding optional features. In this example, the system includes means for transmitting a second data communication signal from the first vehicle toward an object; and means for performing active radar sensing by the first vehicle based on a reflection received by the first vehicle of the second data communication signal.

Example 66 includes the system of any one of examples 57 to 65, including or excluding optional features. In this example, the means for performing radar sensing comprises means for performing active radar sensing by the first vehicle based on a reflection received by the first vehicle of the data communication signal. Optionally, the means for performing radar sensing comprises means for performing coarse sensing for a first distance with a first transmitting signal bandwidth, or means for performing fine sensing for a second distance with a second transmitting signal bandwidth, wherein the second distance is shorter than the first distance, and wherein the second transmitting signal bandwidth is higher than the first transmitting signal bandwidth.

Example 67 is a method of radar sensing by a first device. The method includes transmitting a data communication signal from the first device to a second device; and performing radar sensing by the first device based on the data communication signal, wherein performing radar sensing comprises performing active radar sensing by the first device based on a reflection received by the first device of the data communication signal.

Example 68 includes the method of example 67, including or excluding optional features. In this example, performing radar sensing by the first device based on the data communication signal, wherein performing radar sensing comprises performing active radar sensing by the first device based on a reflection received by the first device of the data communication signal.

Example 69 includes the method of any one of examples 67 to 68, including or excluding optional features. In this example, the data communication signal comprises a preamble of the data communication signal.

Example 70 includes the method of any one of examples 67 to 69, including or excluding optional features. In this example, the data communication signal comprises payload data of the data communication signal.

Example 71 includes the method of any one of examples 67 to 70, including or excluding optional features. In this example, transmitting comprises transmitting the data communication signal over a millimeter wave (mmWave) band, and wherein the reflection of the data communication signal is a reflection off the second device.

Example 72 includes the method of any one of examples 67 to 71, including or excluding optional features. In this example, the first device comprises a vehicle, and wherein the data communication signal comprises a vehicle-to-vehicle (V2V) communication.

Example 73 includes the method of any one of examples 67 to 72, including or excluding optional features. In this example, the method includes prioritizing a message in data communication to increase transmission power in response to a result of the radar sensing.

Example 74 includes the method of any one of examples 67 to 73, including or excluding optional features. In this example, the method includes transmitting a second data communication signal from the first device to an object; and performing active radar sensing by the first device based on a reflection received by the first device of the second data communication signal.

Example 75 includes the method of any one of examples 67 to 74, including or excluding optional features. In this example, performing radar sensing comprises performing coarse sensing for a first distance with a first transmitting signal bandwidth, or performing fine sensing for a second distance with a second transmitting signal bandwidth, wherein the second distance is shorter than the first distance, and wherein the second transmitting signal bandwidth is higher than the first transmitting signal bandwidth.

Example 76 is a method of passive radar sensing by a first device. The method includes receiving a data communication signal at the first device from a second device; and performing the passive radar sensing by the first device based on a reference signal embedded in the data communication signal or on payload data of the data communication signal.

Example 77 includes the method of example 76, including or excluding optional features. In this example, the reference signal comprises a preamble signal.

Example 78 includes the method of any one of examples 76 to 77, including or excluding optional features. In this example, first device comprises a vehicle control system, and wherein the data communication signal comprises a vehicle-to-vehicle (V2V) communication.

Example 79 is a device. The device includes a control system having a transceiver system, the control system to: transmit a data communication signal to a second device; and perform radar sensing based on the data communication signal as reflected from the second device, wherein the radar sensing comprises active radar sensing based on a reference signal embedded in the data communication signal or based on payload data of the data communication signal.

Example 80 includes the device of example 79, including or excluding optional features. In this example, the reference signal comprises a preamble of the data communication signal.

Example 81 includes the device of any one of examples 79 to 80, including or excluding optional features. In this example, the reference signal comprises a pilot of the data communication signal.

Example 82 includes the device of any one of examples 79 to 81 including or excluding optional features. In this example, the control system to receive a second data communication signal transmitted by the second device. Optionally, the control system to perform radar sensing based on the second data communication signal as received.

Example 83 includes the device of any one of examples 79 to 82, including or excluding optional features. In this example, the data communication signal comprises millimeter wave (mmWave).

Example 84 includes the device of any one of examples 79 to 83, including or excluding optional features. In this example, the control system comprises a vehicle computer system, and wherein the data communication signal comprises a vehicle-to-vehicle (V2V) communication.

Example 85 is a tangible, non-transitory computer-readable medium. The tangible, non-transitory computer-readable includes instructions that direct the processor to transmit a data communication signal from the first device to a second device; and perform active radar sensing based on a reference signal embedded in the data communication signal received as reflected from the second device.

Example 86 includes the tangible, non-transitory computer-readable of example 85, including or excluding optional features. In this example, the reference signal comprises a preamble of the data communication signal.

Example 87 includes the tangible, non-transitory of any one of examples 85 to 86, including or excluding optional features. In this example, the data communication signal comprises payload data.

Example 88 includes the tangible, non-transitory of any one of examples 85 to 87, including or excluding optional features. In this example, the code executable by the processor to direct the first device to receive a second data communication signal transmitted by the second device. Optionally, the code executable by the processor to direct the first device to perform passive radar sensing based on the second data communication signal as received.

Example 89 includes the tangible, non-transitory of any one of examples 85 to 88, including or excluding optional features. In this example, the first device comprises a vehicle control system, and wherein the data communication signal comprises a vehicle-to-vehicle (V2V) communication over millimeter wave (mmWave).

It is to be understood that specifics in the aforementioned examples may be used anywhere in one or more embodiments. For instance, all optional features of the computing device described above may also be implemented with respect to either of the methods described herein or a computer-readable medium. Furthermore, although flow diagrams or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method of radar sensing by a first device, comprising:
transmitting a data communication signal from the first device to a second device; and
performing radar sensing by the first device based on the data communication signal, wherein performing radar sensing comprises performing active radar sensing by the first device based on a reflection received by the first device of the data communication signal.

2. The method of claim 1, the data communication signal comprises a reference signal embedded within the data communication signal.

3. The method of claim 1, wherein the data communication signal comprises a preamble of the data communication signal.

4. The method of claim 1, wherein the data communication signal comprises payload data of the data communication signal.

5. The method of claim 1, wherein transmitting comprises transmitting the data communication signal over a millimeter wave (mmWave) band, and wherein the reflection of the data communication signal is a reflection off the second device.

6. The method of claim 1, wherein the first device comprises a vehicle, and wherein the data communication signal comprises a vehicle-to-vehicle (V2V) communication.

7. The method of claim 1, further comprising prioritizing a message in data communication to increase transmission power in response to a result of the radar sensing.

8. The method of claim 1, comprising:
transmitting a second data communication signal from the first device to an object; and
performing active radar sensing by the first device based on a reflection received by the first device of the second data communication signal.

9. The method of claim 1, wherein performing radar sensing comprises performing coarse sensing for a first distance with a first transmitting signal bandwidth, or performing fine sensing for a second distance with a second transmitting signal bandwidth, wherein the second distance is shorter than the first distance, and wherein the second transmitting signal bandwidth is higher than the first transmitting signal bandwidth.

10. A method of passive radar sensing by a first device, comprising:
receiving a data communication signal at the first device from a second device; and
performing the passive radar sensing by the first device based on a reference signal embedded in the data communication signal or on payload data of the data communication signal.

11. The method of claim 10, wherein the reference signal comprises a preamble signal.

12. The method of claim 10, wherein first device comprises a vehicle control system, and wherein the data communication signal comprises a vehicle-to-vehicle (V2V) communication.

13. A device comprising:
a control system having a transceiver system, the control system to:
transmit a data communication signal to a second device; and
perform radar sensing based on the data communication signal as reflected from the second device, wherein the radar sensing comprises active radar sensing based on a reference signal embedded in the data communication signal or based on payload data of the data communication signal.

14. The device of claim 13, wherein the reference signal comprises a preamble of the data communication signal.

15. The device of claim 13, wherein the reference signal comprises a pilot of the data communication signal.

16. The device of claim 13, wherein the control system to receive a second data communication signal transmitted by the second device.

17. The device of claim 16, wherein the control system to perform passive radar sensing based on the second data communication signal as received.

18. The device of claim 13, wherein the data communication signal comprises millimeter wave (mmWave).

19. The device of claim 13, wherein the control system comprises a vehicle computer system, and wherein the data communication signal comprises a vehicle-to-vehicle (V2V) communication.

20. A tangible, non-transitory, computer-readable medium comprising code executable by a processor to direct a first device to:
transmit a data communication signal from the first device to a second device; and
perform active radar sensing based on a reference signal embedded in the data communication signal received as reflected from the second device.

21. The tangible, non-transitory, computer-readable medium of claim 20, wherein the reference signal comprises a preamble of the data communication signal.

22. The tangible, non-transitory, computer-readable medium of claim 20, wherein the data communication signal comprises payload data.

23. The tangible, non-transitory, computer-readable medium of claim 20, wherein the code executable by the processor to direct the first device to receive a second data communication signal transmitted by the second device.

24. The tangible, non-transitory, computer-readable medium of claim 23, wherein the code executable by the processor to direct the first device to perform passive radar sensing based on the second data communication signal as received.

25. The tangible, non-transitory, computer-readable medium of claim 20, wherein the first device comprises a vehicle control system, and wherein the data communication signal comprises a vehicle-to-vehicle (V2V) communication over millimeter wave (mmWave).
